(19) United States
(12) Patent Application Publication
(10) Pub. No.: US 2011/0005827 A1
(43) Pub. Date: Jan. 13, 2011

(54) ELECTRONIC APPARATUS

(76) Inventor: Tsuyoshi Shimomichi, Fuchu-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/708,452

(22) Filed: Feb. 18, 2010

(30) Foreign Application Priority Data
Jul. 13, 2009 (JP) 2009-165066

(51) Int. Cl. H01R 13/508

(52) U.S. Cl. 174/560

(57) ABSTRACT

According to one embodiment, an electronic apparatus includes a first case, a second case, a cover, and a securing member. The first case includes an opening, a first through-hole, and a first edge that defines a periphery of the first through-hole. The second case faces the first case and includes a second through-hole and a second edge that defines a periphery of the second through-hole. A cover is provided so as to cover the opening. A securing member includes an axis portion made to pass through the first through-hole and configured to secure the cover to the first case, and a holding portion that protrudes from the axis portion toward a radial direction of the axis portion and held between the first edge and the second edge. Each of the first edge and the second edge has a diameter smaller than a diameter of the holding portion.

### CROSS-REFERENCE TO RELATED APPLICATIONS

This application is based upon and claims the benefit of priority from Japanese Patent Application No. 2009-165066, filed Jul. 13, 2009, the entire contents of which are incorporated herein by reference.

### BACKGROUND

1. Field

One embodiment of the present invention relates to an electronic apparatus comprising a securing member for securing.

2. Description of the Related Art

Japanese Patent KOKAI Application No. 2006-106618 discloses a display device including a flat display section. This display device comprises a flat display panel, an optical filter member provided on the front surface side of the flat display panel, a frame provided on the back side of the flat display panel, a circuit member provided on the back surface side of the frame, and a back cover provided on a further back surface side than the circuit member. The display device further includes a support mount attached to the frame.

The frame and the support mount are secured by means of a screw, for example. The optical filter member and the frame are also often secured by means of a screw, for example.

When a screw is used in the securing section as described above, when a user has mistakenly lost the unscrewed screw, a problem may occur that makes it impossible to secure again the frame and the support mount, or the optical filter member and the frame.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view illustrating a display device, which is an example of an electronic apparatus according to the first embodiment.

FIG. 2 is an exemplary vertical cross sectional view of the display device shown in FIG. 1.

FIG. 3 is an exemplary exploded perspective view of a first case and a protective plate of the display device shown in FIG. 1.

FIG. 4 is an exemplary vertical cross sectional view of the protective plate, mounting brackets, a screw, the first case, and a second case of the display device shown in FIG. 1.

FIG. 5 is an exemplary vertical cross sectional view of a state in which the protective plate of the display device shown in FIG. 4 is removed from the first case.

FIG. 6 is an exemplary front view illustrating a display device, which is an example of an electronic apparatus according to the second embodiment.

FIG. 7 is an exemplary cross-sectional view along line F7-F7 shown in FIG. 6.

FIG. 8 is an exemplary perspective view illustrating a remote operation device, which is an example of an electronic apparatus of the third embodiment.

FIG. 9 is an exemplary cross-sectional view along line F9-F9 shown in FIG. 8.

FIG. 10 is an exemplary perspective view illustrating a hard disk drive apparatus, which is an example of an electronic apparatus of the fourth embodiment.

FIG. 11 is an exemplary perspective view illustrating a module capable of being inserted into or removed from a slot in a hard disk drive shown in FIG. 10.

FIG. 12 is an exemplary cross-sectional view horizontally along the hard disk drive apparatus shown in FIG. 10.

FIG. 13 is an exemplary cross-sectional view along a lengthwise direction of a display device, which is an example of an electronic apparatus according to the fifth embodiment.

### DETAILED DESCRIPTION

Various embodiments according to the invention will be described hereinafter with reference to the accompanying drawings. In general, according to one embodiment of the invention, an electronic apparatus includes a first case, a second case, a cover, and a securing member. The first case includes an opening, a first through-hole, and a first edge that defines a periphery of the first through-hole. The second case faces the first case and includes a second through-hole and a second edge that defines a periphery of the second through-hole. A cover is provided so as to cover the opening. A securing member includes an axis portion made to pass through the first through-hole and configured to secure the cover to the first case, and a holding portion that protrudes from the axis portion toward a radial direction of the axis portion and held between the first edge and the second edge. Each of the first edge and the second edge has a diameter smaller than a diameter of the holding portion.

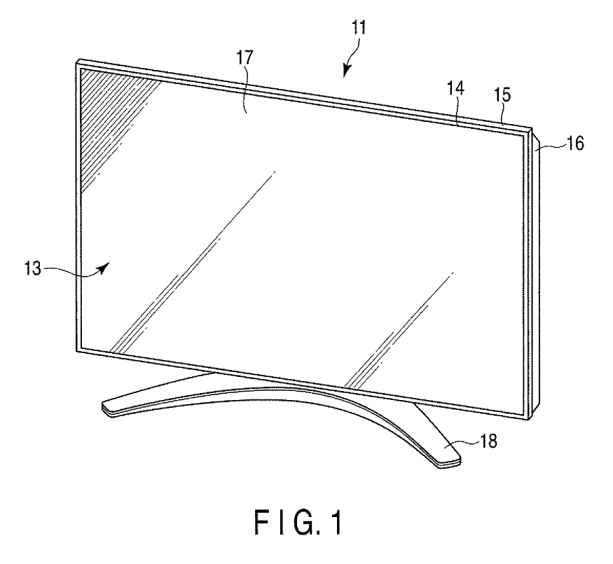

Hereinafter, an embodiment will be described, in which the electronic apparatus is applied to a display device, such as a flat-screen television, as an example with reference to FIGS. 1-5.

As shown in FIGS. 1-3, the display device 11 comprises a frame 12, a display panel 13 mounted on the front surface of the frame 12, a first case 15 covering the front surface of the display panel 13 and including an opening 14, a second case 16 facing the first case 15 so as to cover the back surface of the frame 12, a protective plate 17 attached to the first case 15 so as to cover the opening 14, a stand 18 supporting the frame 12 in a standing position, a panel controller 21 configured to drive the display panel 13, and a power unit 22 configured to supply electric power to the display panel 13 and the like. The panel controller 21 and the power unit 22 are secured to the back surface of the frame 12.

The protective plate 17 is a quadrilateral transparent flat plate formed of acrylic resin, for example. The protective plate 17 prevents reflection of outer light and protects the display panel 13 from physical damage. The display 13 is formed of a liquid crystal panel, for example, but is not limited thereto. The display panel 13 may be other panels such as plasma display panel and organic electro-luminescence display. The protective plate 17 corresponds to a cover of the present invention.

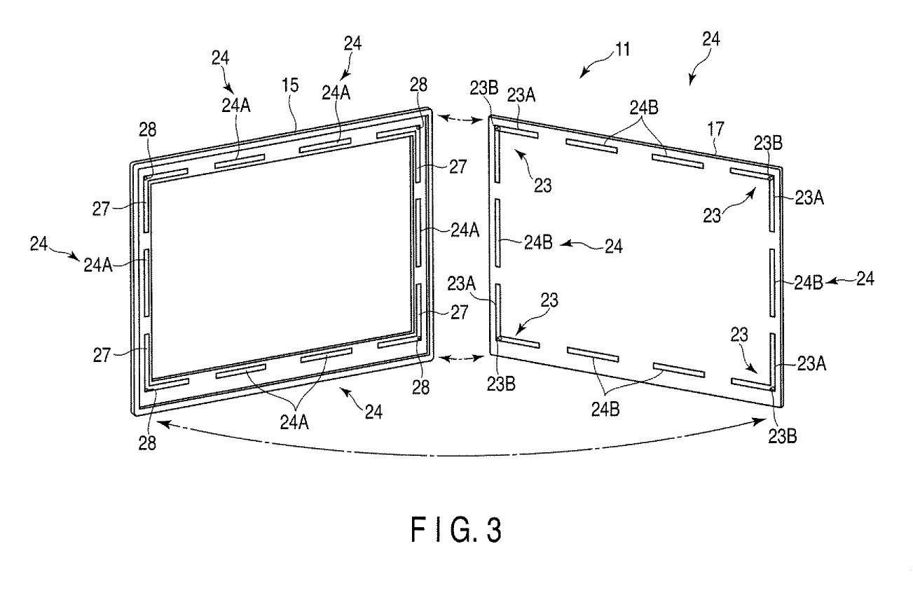

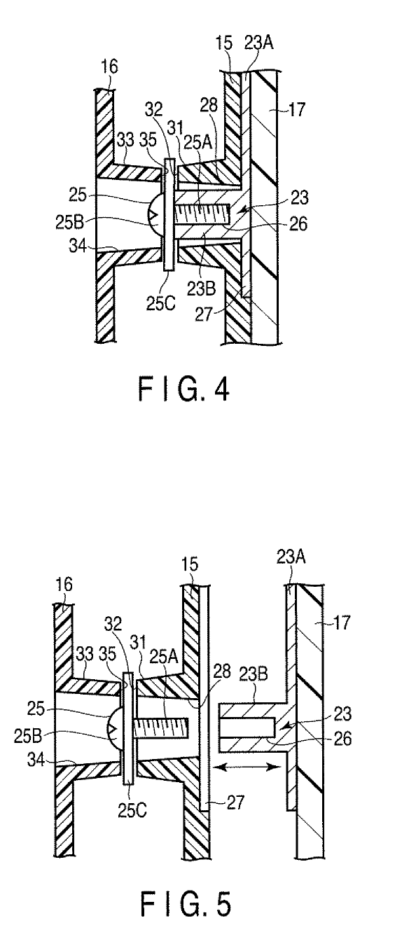

As shown in FIGS. 3 and 4, the display device 11 further includes a mounting bracket 23 and a fastener member 24 interposed between the first case 15 and the second case 16, and a screw 25, which is an example of a securing member configured to secure the first case 15 and the protective plate 17. The mounting bracket 23 is provided in four places, so as to correspond to the corner portions of the protective Plate 17. The mounting bracket 23 includes an L-shaped securing member 23A and a cylindrical pin 23B that protrudes from the corner portion of the L-shaped securing member 23A. The securing member 23A of the mounting bracket 23 is adhered to the protective plate 17 via a double-stick tape, for example. The pin 23B includes a screw hole 26 into which the screw 25 is inserted at the center part. The pin 23B extends in the direction crossing the protective plate 17, i.e., the direction perpendicular to the protective plate 17.

As shown in FIG. 3, the fastener member 24 includes a first portion 24A adhered to the first case 15, and a second portion 24B adhered to the protective plate 17. The first portion 24A and the second portion 24B of the fastener member 24 can be attached to or detached from each other, and adhere to each other by being pressed against the surface of each other. The fastener member 24 is formed of a hook and loop fastener under the registered trademark Magic Tape. Both the first portion 24A and the second portion 248 have the shape of sheets.

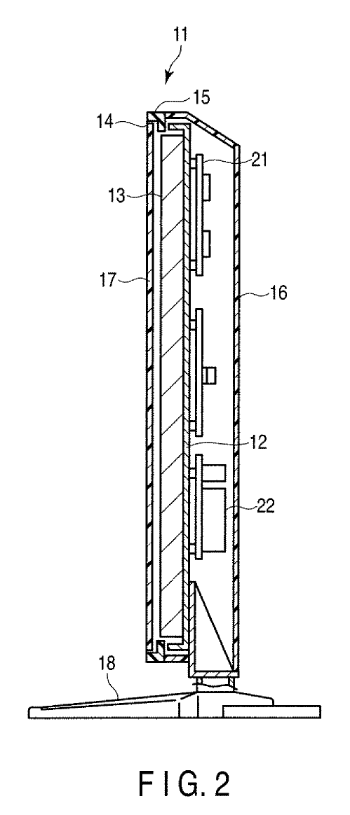

As shown in FIGS. 1 and 2, the opening 14 is provided on approximately the entire front surface of the first case 15. The opening 14 exposes the display panel 13 toward the outside.

As shown in FIGS. 3 and 4, the first case 15 is formed in the shape of a frame so as to surround the periphery of the front surface of the display panel 13. The first case 15 includes a concave portion 27, in which the mounting bracket 23 is engaged, a first through-hole 28, which is provided in the concave portion 27 and through which the bin 23B passes, a cylindrical first boss portion 31 provided in the periphery of the first through-hole 28, and a first edge 32 provided at the top portion of the first boss portion 31. The first boss portion 31 protrudes toward the second case 16 on the surface opposite to the surface on which the concave portion 27 is provided. The height dimension of the first boss portion 31 is greater than the length dimension of an axis portion 25A of the screw 25, which will be described later. The first edge 32 defines the periphery of the first through-hole 28.

The second case 16 includes a second boss portion 33 that protrudes toward the first case 15, a second through-hole 34 provided at the central part of the second boss portion 33 so as to pass through the second case 16, and a second edge 35 provided at the top portion of the second boss portion 33. The second boss portion 33 is formed in a cylindrical shape. The second edge 35 defines the periphery of the second through-hole 34.

The screw 25 is provided at four places so as to correspond to the corner portions of the protective plate 17, for example. As shown in FIGS. 4 and 5, the screw 25 includes a cylindrical axis portion 25A including a male screw on the outer peripheral surface, a head portion 25B provided at one end of the axis portion 25A, a disc-shaped holding portion 25C protruding in a radial direction of the axis portion 25A from the axis portion 25A. The axis portion 25A passes through the first through-hole 28, and the protective plate 17 can be secured to the first case 15. The holding portion 25C protrudes in the shape of a flange from the axis portion 25A. The holding portion 25C protrudes from said one end of the axis portion 25A, and is integrally formed with the head portion 255. The holding portion 25C is held between the first edge 32 and the second edge 35. The diameters of the first edge 32 and the second edge 35 are smaller than the diameter of the disc-shaped holding portion 25C.

The mounting operation of the protective plate 17 of the present embodiment will be described with reference to FIGS. 4 and 5. As shown in FIG. 5, the first case 15 and the second case 16 are secured in advance so as to interpose the holding portion 25C of the screw 25 between the first edge 32 and the second edge 35. The pin 23B of the mounting bracket 23 is inserted into the inside of the first through-hole 28 of the first case 15. Further, the protective plate 17 is secured to the first case 15 by rotating the screw 25 clockwise, for example, by means of a screwdriver, for example, inserted into the second through-hole 34. In this case, the mounting bracket 23 fits into the concave portion 27.

In order to remove the protective plate 17 from the first case 15 from the state shown in FIG. 4, on the other hand, the screw 25 is rotated anticlockwise, for example, by means of a screwdriver inserted into the second through-hole 34, for example. The rotation of the screw 25 allows the pin 235 and the protective plate 17 to be pushed forward, and the protective plate 17 to be removed from the first case 15.

According to the first embodiment, the electronic apparatus comprises: the first case 15 including the opening 14, the first through-hole 28, the first edge 32 defining the periphery of the first through-hole 28; the second case 16 including the second through-hole 34 and the second edge 35 defining the periphery of the second through-hole 34 and facing the first case 15; the cover provided so as to cover the opening 14; and the screw 25 including an axis portion 25A made to pass through the first through-hole 28 and allowing the cover to be secured to the first case 15, and a holding portion 25C protruding in a radial direction of the axis portion 25A from the axis portion 25A and held between the first edge 32 and the second edge 35, and the first edge 32 and the second edge 35 have diameters smaller than the diameter of the holding portion 25C.

According to this configuration, since the holding portion 25C is held between the first edge 32 and the second edge 35, the screw 25 is prevented from dropping from between the first case 15 and the second case 16. This makes it possible to prevent a case where a user mistakenly loses the screw 25 when the user removes the cover for cleaning of the periphery of the opening 14. Further, according to the above-described configuration, the screw 25 can be rotated in clockwise or anticlockwise direction by making a screwdriver pass through the second through-hole 34, the operability of the screw 25 is not decreased.

In this case, the first boss portion 31 provided in the first case 15 so as to protrude toward the second case 16 and including the first edge 32 at the top portion thereof is further provided, such that the height dimension of the first boss portion 31 is greater than the length dimension of the axis portion 25A. According to this configuration, the axis portion 25A of the screw 25 is prevented from protruding from the surface of the first case 15. This prevents cases where the user gets his or her finger or a cable caught in the axis portion 25A by mistake, and damages the first edge 32 and the second edge 35 holding the screw 25 or cuts off the cable.

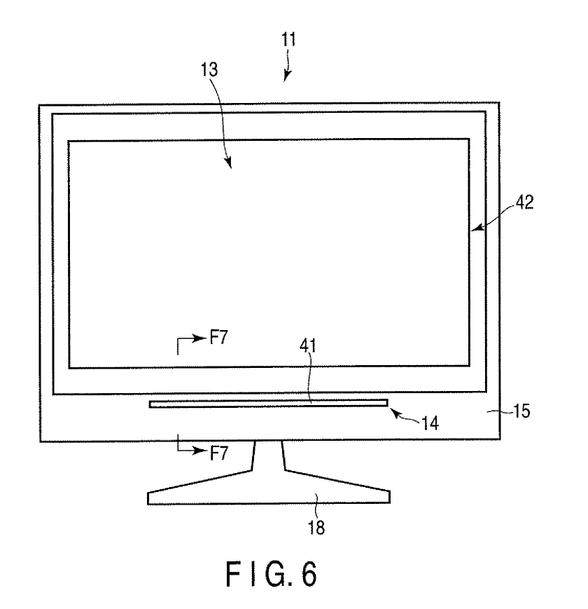

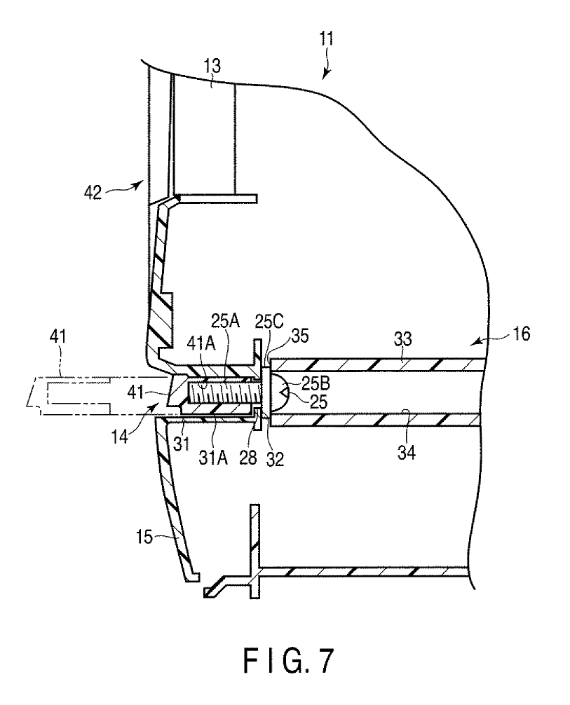

Next, the second embodiment of an electronic apparatus will be described with reference to FIGS. 6 and 7. A display device 11, such as a flat-screen television, which is an example of the electronic apparatus of the second embodiment, is different from the first embodiment in that a dress panel 41 which can be attached to and detached from the first case 15 is provided, and the opening 14 has different dimensions, but the other configurations are common to those of the first embodiment. Accordingly, different parts will mainly be discussed, and common parts will be denoted by the common reference numbers and detailed description of such parts will be omitted.

The display device 11 of the second embodiment independently includes a second opening 42 for exposing the display panel 13 to the outside, in addition to the opening 14. The opening 14 is provided in the shape of a crosswise slit at a portion under the first case 15. The dress panel 41 is formed of a synthetic resin material so as to cover the opening 14. The dress panel 41 corresponds to the cover of the present invention. The screw 25, which is an example of the securing member, is provided in two places corresponding to the right and left ends of the dress panel 41. The dress panel 41 further includes a screw hole 41A, into which the screw 25 is secured.

The first case 15 includes a first through-hole 28 through which the screw 25 passes, a first boss portion 31 provided in the periphery of the first through-hole 28, and a first edge 32 defining the periphery of the first through-hole 28. The first boss portion 31 protrudes toward the second case 16. A recess portion 31A is provided inside the first boss portion 31. The dress panel 41 is entirely fit into the inside of the recess portion 31A.

The second case 16 includes a second boss portion 33 protruding toward the first case 15, a second through-hole 34 provided so as to pass through the second case 16 at the center part of the second boss portion 33, and a second edge 35 defining the periphery of the second through-hole 34. The second boss portion 33 forms a cylindrical shape. A holding portion 25C of the screw 25 is held between the first edge 32 and the second edge 35. The diameter of the disc-shaped holding portion 25C of the screw 25 is greater than the diameters of the first edge 32 (first through-hole 28) and the second edge 35 (second through-hole 34).

The mounting operation of the dress panel 41 of the present invention will be described with reference to FIG. 7. The first case 15 and the second case 16 are secured in advance so as to interpose the holding portion 25C of the screw 25 between the first edge 32 and the second edge 35. After that, the dress panel 41 is inserted into the inside of the recess portion 31A of the first boss portion 31. Further, the screw 25 is rotated clockwise, for example, by means of a screwdriver made to pass through the second through-hole 34, for example, such that the dress panel 41 is secured to the first case 15.

In order to remove the dress panel 41 from the first case 15 from the state shown in FIG. 7, on the other hand, the screw 25 is rotated anticlockwise by means of a screwdriver, for example, made to pass through the second through-hole 34. The rotation of the screw 25 allows the dress panel 41 to be pushed forward removed from the first case 15.

According to the second embodiment, since the holding portion 25C is interposed between the first edge 32 and the second edge 35, the screw 25 is prevented from dropping from between the first case 15 and the second case 16. This prevents a case where a user mistakenly loses the screw 25 when the user removes the cover for cleaning of the periphery of the opening 14. Further, the configuration of the present invention can be applied to the screw 25 that secures the dress panel 41, as in the present embodiment.

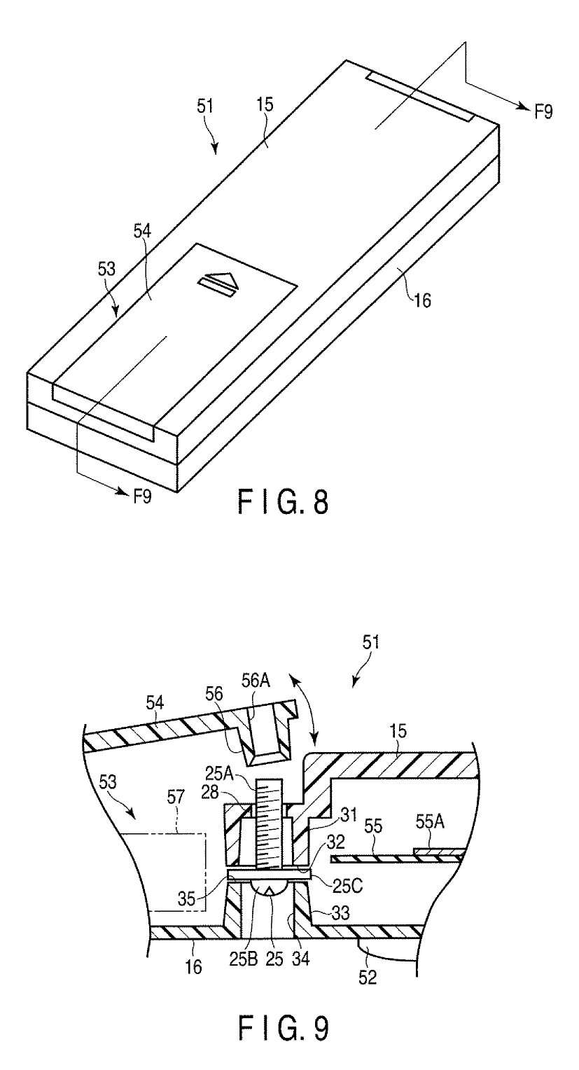

Next, the third embodiment of the electronic apparatus will be described with reference to FIGS. 8 and 9. A remote control device (RC) 51 for a flat-screen television, which is an example of an electronic apparatus of the third embodiment, is different from the first embodiment in the configuration of the periphery of the opening 14, but the other configurations are mostly common to those of the first embodiment in substance. Accordingly, different parts will mostly be discussed, and common parts will be denoted by common reference numbers and detailed descriptions of such configurations will be omitted.

As shown in FIG. 8, the remote control device 51 comprises a first case 15 including an opening 14, a second case 16 including a plurality of operation buttons 52, a cell container 53 provided so as to be continuous with the opening 14, a lid 54 attached to the first case 15 so as to cover the opening 14 and the cell container 53, and a printed circuit board 55 contained in the first case 15 and the second case 16 and including a plurality of circuit components 55A. In other words, the first case 15 covers one surface of the printed circuit board 55, and the second case 16 covers the other surface of the printed circuit board 55. A cell 57 is contained in the cell container 53. The lid 54 corresponds to the cover of the present invention.

The first case 15 includes a first through-hole 28, through which the screw 25 passes, a cylindrical first boss portion 31 provided in the periphery of the first through-hole 28, and a first edge 32 defining the periphery of the first through-hole 28. The first boss portion 31 protrudes toward the second case 16. The first boss portion 31 covers the periphery of an axis portion 25A of the screw 25.

The second case 16 includes a second boss portion 33 protruding toward the first case 15, a second through-hole 34 provided so as to pass through the second case 16 at the central part of the second boss portion 33, and a second edge 35 defining the periphery of the second through-hole 34. The second boss portion 33 has a cylindrical shape. The lid 54 includes a third boss portion 56 protruding toward the first case 15, and a screw hole 56A, which is provided at the third boss portion 56 and to which the screw 25 is secured.

The screw 25 is provided in one place, for example. The diameter of the disc-shaped holding portion 25C of the screw 25 is greater than the diameters of the first edge 32 (first through-hole 28) and the second edge 35 (second through-hole 34).

The operations of attaching and detaching the lid 54 of the present embodiment will be described below with reference to FIG. 9. As shown in FIG. 9, the first case 15 and the second case 16 are secured in advance so as to interpose the holding portion 25C of the screw 25 between the first boss portion 31 and the second boss portion 33. After that, the lid 54 is temporarily secured to the opening 14 of the first case 15. Further, the screw 25 is rotated clockwise by means of a screwdriver made to pass through the second through-hole 34, for example, such that the lid 54 is completely secured to the first case 15.

In order to remove the lid from the first case 15 from the state shown in FIG. 8, on the other hand, the screw 25 is rotated anticlockwise by means of a screwdriver, for example, penetrating through the second through-hole 34. The rotation of the screw 25 allows the lid 54 to be pushed in a direction away from the first case 15 and removed from the first case 15.

According to the third embodiment, the electronic apparatus comprises the cell container 53 provided so as to be continuous with the opening 14, and the cover covers the cell container 53. According to this configuration, the structure of preventing loss of the screw 25 can also be adopted for the cover covering the cell container 53.

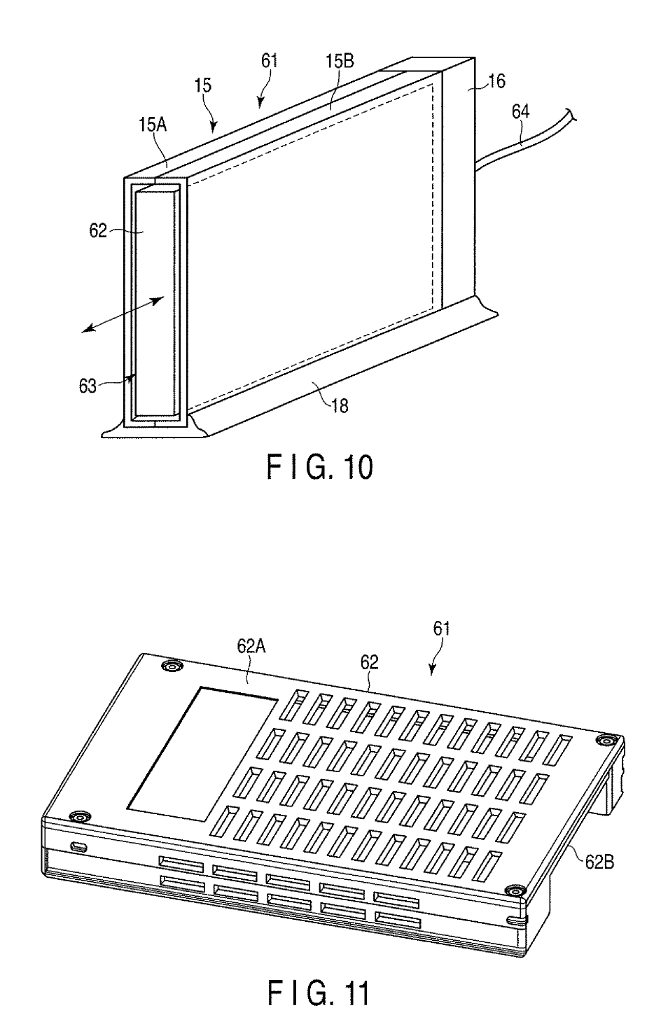

Next, the fourth embodiment of the electronic apparatus will be described with reference to FIGS. 10-12. An external hard disc drive (HOD) 61, which is an example of an electronic apparatus of the fourth embodiment, is different from the first embodiment in that a module 62, instead of the cover (protective plate 17), is secured by means of a screw 25, which is an example of a securing member, but is common to the first embodiment in regard to the other configurations. Accordingly, different configurations will mostly be discussed, and common configurations will be denoted by the same reference numbers and detailed descriptions of such elements will be omitted. The hard disc drive 61 is connected to a display device, such as a television, and is capable of recording videos such as television programs, or outputting recorded videos to a display device 11.

The hard disc drive 61 comprises a first case 15 including a slot 63, a second case 16 attached to the first case 15, a module 62 detachably attached to the inside of the slot 63, a connector provided inside the slot 63 and configured to be connected to the module 62, and a stand 18 holding the first case 15 and the second case 16 in a standing position. Further, the hard disc drive 61 includes a cable 64 configured to connect the hard disc drive 61 to the display device 11, such as a television.

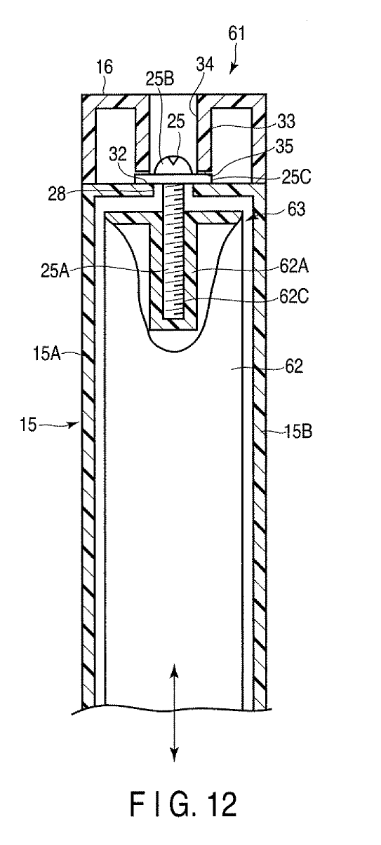

The first case 15 is formed in the shape of a hollow box including a slot 63 inside. As shown in FIG. 10, the first case 15 is vertically divided into two so as to include a first portion 15A and a second portion 15B. As shown in FIG. 12, the first case 15 includes a first through-hole 28, through which the axis portion 25A of the screw 25 passes, and a first edge 32, which defines the periphery of the first through-hole 28 and in which the holding portion 25C of the screw 25 is engaged. An opening of the slot 63 is provided in a quadrilateral shape on the approximately entire front surface of the first case 15.

The second case 16 is secured to the first case 15 by means of a screw clamp, for example. The second case 16 includes a second boss portion 33 protruding toward the first case 15, a second through-hole 34 provided so as to pass through the second case 16 at the central part of the second boss portion 33, and a second edge 35 defining the periphery of the second through-hole 34. The second boss portion 33 has a cylindrical shape.

The module 62 is a main body of the hard disc drive 61. The module 62 may be used by being attached to or detached from the inside of the slot 63. The module 62 comprises an external case 62A forming the outer shell thereof, a connecting portion 62B connected to a connector provided in the first case 15, and a screw hole 620, into which the screw 25 is inserted. It is to be noted that the module 62 is not limited to a hard disc drive. The module 62 may be other storage devices, such as a solid-state drive (SSD) or a flash memory drive, or optical drive devices such as a DVD or a CD.

The screw 25 is provided in one place in the back portion of the slot 63, for example. The screw 25 comprises a cylindrical axis portion 25A including a male screw formed on an external peripheral surface thereof, a top portion 25B provided at one end of the axis portion 25A, and a disc-shaped holding portion 25C protruding in a radial direction of the axis portion 25A from the axis portion 25A. The axis portion 25A passes through the first through-hole 28, and a portion of the tip side thereof projects into the inside the slot 63. The holding portion 25C is held between the first edge 32 and the second edge 35. The diameters of the first edge 32 (first through-hole 28) and the second edge 35 (second through-hole 34) are smaller than the diameter of the disc-shaped holding portion 25C.

The mounting operation of the protective plate 17 of the present embodiment will be described with reference to FIGS. 10 and 12. As shown in FIG. 12, the first case 15 and the second case 16 are secured in advance so as to interpose the holding portion 25C of the screw 25 between the first edge 32 and the second edge 35. After that, a module 62 is inserted into the inside of the slot 63 of the first case 15. Further, the screw 25 is rotated clockwise, for example, by means of a screwdriver, for example, made to pass through the second through-hole 34, for example. Thus, the module 62 is pulled into the slot 63 and secured to the first case 15.

In order to remove the module 62 from the first case 15 from the state shown in FIG. 12, on the other hand, the screw 25 is rotated anticlockwise by means of a screwdriver, for example, made to pass through the second through-hole 34. The rotation of the screw 25 allows the module 62 to be pushed forward and removed from the inside of the slot 63.

According to the fourth embodiment, the electronic apparatus comprises: a first case 15 including a slot 63, a first through-hole 28, and a first edge 32 defining the periphery of the first through-hole 28; a second case 16 including a second through-hole 34 and a second edge 35 defining the periphery of the second through-hole 34; a module 62 which can be attached to and detached from the inside of the slot 63; a screw 25 including an axis portion 25A made to pass through the first through-hole 28 and configured to secure the module 62 to the inside of the slot 63 and pushing the module 62 from the inside of the slot 63, and a holding portion 25C protruding in a radial direction of the axis portion 25A from the axis portion 25A and held between the first edge 32 and the second edge 35, and the first edge 32 and the second edge 35 have diameters smaller than the diameter of the holding portion 25C.

According to this configuration, since the holding portion 25C is interposed between the first edge 32 and the second edge 35, it is possible to prevent a case where the screw 25 drops from between the first case 15 and the second case 16 and is lost. Further, since the module 62 can be attached and detached by means of the screw 25, a hand-pull does not need to be provided in the module 62, and the module 62 can be made compact.

Further, a portion of the axis portion 25A protrudes into the inside of the slot 63. According to this configuration, since the axis portion 25A does not protrude toward the outside, it is possible to prevent a case where the user mistakenly gets his or her finger or a cable caught in the axis 25A and damages the first edge 32 and the second edge 35 holding the screw 25.

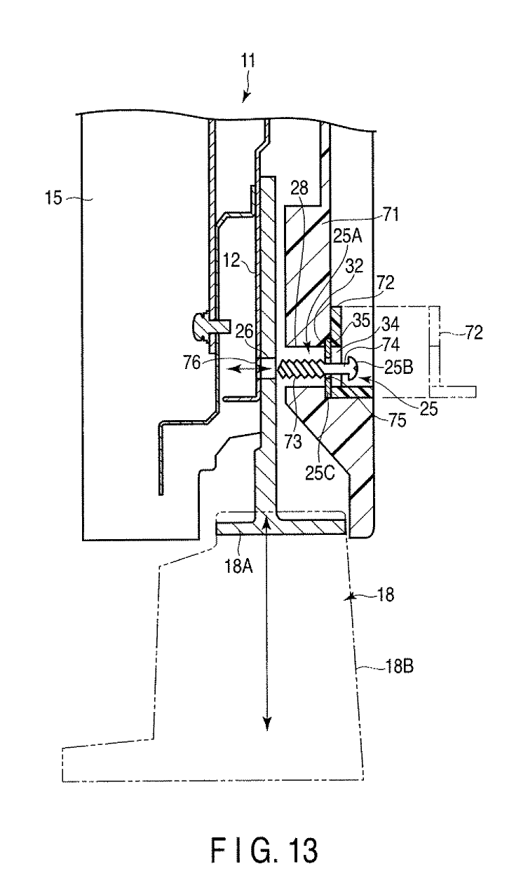

Next, the electronic apparatus according to the fifth embodiment will be described with reference to FIG. 13. The display device 11 of a flat-screen television, for example, which is an example of the electronic apparatus of the fifth embodiment, is different from the first embodiment in that a stand 18, instead of the cover (protective plate 17), is secured by means of a screw 25, which is an example of a securing member, but the other configurations are common to those of the first embodiment. Accordingly, only different configurations will mostly be discussed, and common configurations will be denoted by the common reference numbers and detailed description of such configurations will be omitted. The display device 11 of the fifth embodiment has the same outer appearance as that of the first embodiment shown in FIG. 1.

As shown in FIG. 13, the display device 11 comprises a frame 12, a display panel 13 attached to the front surface of the frame 12, a first case 15 covering the front surface of the display panel 13, a case body 71 covering the back surface of the frame 12, a stand 18 detachably attached to the frame 12, a screw 25 securing the frame 12 and the stand 18, and a holding member 72 attached to the case body 71.

The stand 18 can support the frame 12 in a standing position (vertically). The stand 18 includes a stand body 18A formed of a metal material so as to have a T-shaped cross-section, and a leg portion 18B formed of synthetic resin, for example, and secured to the stand body 18A. The stand body 18A includes a screw hole 26, into which the screw 25 is inserted. The frame 12 further includes a receiving hole 76, into which the screw 25 is inserted. The receiving hole 76 and the axis portion 25A held by the holding portion 25C, which will be described later, allow the stand body 18A to be reliably secured to the frame 12.

The case body 71 includes a through-hole 28, through which the screw 25 passes, and a first edge 32 defining the periphery of the first through-hole 28. The first edge 32 is formed as a stepped portion lower than the periphery of the first cast 15 by one step. The holding portion 25C of the screw 25 is configured to be engaged in the first edge 32.

The holding member 72 is detachably attached to the case body 71 by securing means independent from the screw 25, such as other screws. The holding member 72 has an L-shaped cross-section. The holding member 72 includes a second through-hole 34 and a second edge 35 defining the periphery of the second through-hole 34.

The screw 25 is provided in two places corresponding to the both ends of the stand 18 in the width direction. The screw 25 includes an axis portion 25A, a head portion 25B provided at one end of the axis portion 25A, and a washer-shaped holding portion 25C attached to the axis portion 25A, so as to be slidably movable with respect to the axis portion 25A. The axis portion 25A includes a male screw portion 73 including a male screw on an outer peripheral surface thereof, and a cylindrical slide portion 74 including a smooth peripheral surface. The slide portion 74 of the axis portion 25A fits into the third through-hole 75 of the holding portion 25C, which will be described below, while allowing play. Accordingly, the axis portion 25A is slidably movable in the direction in which the axis portion 25A extends toward the holding portion 25C.

The holding portion 25C includes a third through-hole 75, for allowing the slide portion 74 to pass through, at the central part thereof. The holding portion 25C is formed in the shape of a ring held to the outside of the axis portion 25A, while allowing play. The holding portion 25C is held between the first edge 32 and the second edge 35. The diameters of the first edge 32 (first through-hole 28) and the second edge 35 (second through-hole 34) are smaller than the diameter of the disc-shaped holding portion 25C.

The operations of attaching and detaching the stand 18 of the present embodiment will be described below, with reference to FIG. 13. As shown in FIG. 13, the holding member 72 is secured in advance to the case body 71 so as to interpose the holding portion 25C of the screw 25 between the first edge 32 and the second edge 35. After that, the screw 25 is rotated clockwise, for example, by means of a screwdriver, for example, made to pass through the second through-hole 34, such that the stand 18 is secured to the frame 12.

In order to remove the stand 18 from the frame 12 from the state show in FIG. 13, on the other hand, the screw 25 is rotated anticlockwise, for example, by means of a screwdriver made to pass through the second through-hole 34. The rotation of the axis portion 25A allows the axis portion 25A to move back from the holding portion 25C and pushed in the direction away from the stand 18. Thereby, the secured state of the stand 18 is released, and the stand 18 can be removed from the frame 12 by pulling down the stand 18.

According to the fifth embodiment, the electronic apparatus comprises: a frame 12, a display panel 13 attached to the frame 12, a case body 71 secured to the frame 12 and including a first through-hole 28 and a first edge 32 that defines a periphery of the first through-hole 28, a holding member 72 including a second through-hole 34, a second edge 35 defining the periphery of the second through-hole 34 and attached to the case body 71, a stand 18 supporting the frame 12 in a standing position, and a screw 25 including an axis portion 25A made to pass through the first through-hole 28 and configured to secure the stand 18 to the frame 12; and a holding portion 25C protruding in a radial direction of the axis portion 25A from the axis portion 25A and held between the first edge 32 and the second edge 35, and the first edge 32 and the second edge 35 have diameters smaller than the diameter of the holding member 25C.

According to this configuration, since the holding portion 25C is interposed between the first edge 32 and the second edge 35, the screw 25 is prevented from falling from between the case body 71 and the holding member 72. Thereby, when the user removes the stand 18 and uses the electronic apparatus by hanging it on the wall for a long period of time, it is possible to prevent the screw 25 from being mistakenly lost.

In this case, the axis portion 25A can be moved forward and backward in the direction in which the axis portion 25A extends, with respect to the holding portion 25C. According to this configuration, the axis portion 25A itself of the screw 25 can be moved forward and backward with respect to the stand 18. Thereby, the structure of interposing the screw 25 between the first edge 32 and the second edge 35 can be adopted to the structure of securing the stand 18, for example, attached and detached in the direction crossing the direction in which the screw 25 is inserted.

The electronic apparatus of the present invention is not limited to a flat-screen television, but can be embodied as a display for a personal computer, for example. Further, the electronic apparatus of the present invention can be applied to other devices such as cellular phones. Moreover, the display device may be embodied with various modifications as long as it does not depart from the spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An electronic apparatus, comprising:
a first case including an opening, a first through-hole, and a first edge that defines a periphery of the first through-hole;
a second case facing the first case and including a second through-hole and a second edge that defines a periphery of the second through-hole;
a cover provided so as to cover the opening;
a securing member including an axis portion made to pass through the first through-hole and configured to secure the cover to the first case, and a holding portion that protrudes from the axis portion toward a radial direction of the axis portion and held between the first edge and the second edge,
wherein the first edge and the second edge have diameters smaller than a diameter of the holding portion.

2. The electronic apparatus of claim 1, further comprising a first boss portion provided in the first case so as to protrude toward the second case and including the first edge provided at a top portion of the first boss portion,
wherein a height dimension of the first boss portion is greater than a length dimension of the axis portion.

3. The electronic apparatus of claim 2, further comprising a pin that extends in a direction crossing the cover, the pin being made to pass through the first through-hole, wherein the securing member is secured to the pin.

4. The electronic apparatus of claim 2, further comprising a cell container provided so as to be continuous with the opening, wherein the cover covers the cell container.

5. An electronic apparatus comprising:
a first case including a slot, a first through-hole, and a first edge defining a periphery of the first through-hole;
a second case including a second through-hole and a second edge defining a periphery of the second through-hole;
a module capable of being attached to or detached from an inside of the slot; and
a securing member including an axis portion made to pass through the first through-hole and configured to secure the module to the inside of the slot and push the module from the inside of the slot, and a holding portion protruding in a radial direction of the axis portion from the axis portion and interposed between the first edge and the second edge,
wherein each of the first edge and the second edge has a diameter smaller than a diameter of the holding portion.

6. The electronic apparatus of claim 5, wherein a portion of the axis portion protrudes into the slot.

7. An electronic apparatus, comprising:
a frame;
a display panel attached to the frame;
a case body secured to the frame and including a first through-hole and a first edge that defines a periphery of the first through-hole;
a holding member attached to the case body and including a second through-hole and a second edge that defines a periphery of the second through-hole;
a stand configured to support the frame in a standing position;
a securing member including an axis portion made to pass through the first through-hole and configured to secure the stand to the frame, and a holding portion that protrudes in a radial direction of the axis portion from the axis portion and held between the first edge and the second edge,
wherein each of the first edge and the second edge has a diameter smaller than a diameter of the holding portion.

8. The electronic apparatus of claim 7, wherein the axis portion is capable of moving forward and backward in a direction in which the axis portion extends with respect to the holding portion.
